(19) United States
(12) Patent Application Publication
(10) Pub. No.: US 2017/0247147 A1
(43) Pub. Date: Aug. 31, 2017

(54) Paint Can Lid Pour Spout

(71) Applicant: Ubirajara Gama, El Cerrito, CA (US)

(72) Inventor: Ubirajara Gama, El Cerrito, CA (US)

(21) Appl. No.: 15/055,556

(22) Filed: Feb. 27, 2016

(51) Int. Cl. B65D 25/48; B65D 47/06; B01F 15/02; B44D 3/08; B01F 7/18; B44D 3/12; B65D 47/28

(52) U.S. Cl. CPC B65D 25/48; B44D 3/127; B65D 47/06; B65D 47/286; B44D 3/08; B01F 7/18; B01F 15/0234; B01F 15/0295; B01F 2215/005

(57) ABSTRACT

A paint container lid assembly for a standard paint container includes an opening with a threaded adapter ring and a removable threaded cap. A pour spout/funnel includes a tubular lower portion having an internally threaded end to removably engage the adapter ring. The upper portion of the spout/funnel comprises a coffer-like body having an elongated opening. A spout/funnel cap is slidably secured to the spout/funnel to close the entire spout/funnel upper opening or partially unblock the opening to meter and control the rate of outflow of paint.

### CROSS-REFERENCE TO RELATED APPLICATIONS

Not applicable

### FEDERALLY SPONSORED RESEARCH

Not applicable.

### SEQUENCE LISTING, ETC ON CD

Not applicable.

### BACKGROUND OF THE INVENTION

Field of the Invention

This invention relates to an improved closure for paint containers and, more particularly, to a paint container lid that incorporates a pour spout and funnel.

Description of Related Art

Paint for household and industrial purposes is generally sold in standard capacity containers that are conventional in construction. That is, a common paint can is provided with a removable lid pressed into an opening disposed at the top of the can and secured therein by the engagement of a downwardly projecting annular flange formed around the perimeter of the lid with a conforming annular flange secured within the perimeter of the opening of the can. The lid is released by prying the lid flange upwardly to release the flanged engagement. Alternatively, larger containers may comprise a bucket formed of polymer or plastic material with a lid having a peripheral rim that is press-fit about the top of the bucket.

When the user accesses the paint, it is first prudent to stir the paint to assure uniform mixing of the paint constituents to form a consistent paint application. Stirring a full container, in which the liquid level is proximate to the container opening, may creates the common problem of waves in the liquid overtopping the opening spilling out and down the sides of the container. Later, when the liquid is poured from the top opening it often collects at the top flange or top rim of the container or spills down the sides. It is prudent to reseal the container to prevent contamination of the paint from airborne dust and spray, and to prevent the paint from drying as it is exposed to air. The paint tends to fill the flanged rim of the container, and pressing the lid into the flange to reseal the container displaces the accumulated paint in the flange area and causes it to drip down the sides, resulting in a messy workplace and necessitating actions to contain the paint and prevent extensive cleanup operations. Often the container must be opened and resealed numerous times before the contents are completely used.

These problems are exacerbated when a paint roller is employed, as the roller tray, which necessarily has a limited capacity, must be refilled numerous time. When the paint rolling tasks are completed, it is often necessary to pour the unused remaining paint in the roller tray back into the container, a sloppy task that often results in spills. The more spills that are caused, the more time is required to clean the job site.

### BRIEF SUMMARY OF THE INVENTION

The present invention generally comprises a paint container lid assembly that incorporates a pour spout and funnel, and facilitates easy access to the paint without causing the spills and mess often associated with paint containers.

The paint container lid assembly includes a lid dimensioned and configured to fit a standard paint container such as a one gallon or five gallon container. The lid is provided with an access opening disposed medially between the center of the lid and the rim thereof. An adapter ring is dimensioned to be received in the access opening, and includes a lower end having external threads. A retaining ring is provided with internal threads and is secured to the lower end of the adapter ring to secure the ring in the access opening. A medial flange extends outwardly from the adapter ring to impinge on the upper surface of the lid. The upper end of the adapter ring is a collar that is also provided with external threads, and a cap having complementary internal threads is removably secured to the collar to seal the opening of the adapter ring.

A salient aspect of the invention is the provision of a pour spout/funnel that is removably secured to the collar of the adapter ring. The spout/funnel includes a tubular lower portion having an internally threaded end that engages the threads of the collar to secure it to the adapter ring. The upper portion of the spout/funnel comprises a coffer-like body having an end that flares radially from the tubular lower portion and is defined by a smoothly contoured surface extending therefrom. The upper end of the spout/funnel is an enlongated opening having opposed parallel linear sides joined by smoothly curved opposed ends, and it provides a direct liquid flow connection to the adapter ring.

The spout/funnel includes linear flanges extending in opposed outward fashion from the linear sides of the opening. A spout/funnel cap is provided, and includes a generally flat panel having a perimeter that conforms to the size and shape of the spout/funnel opening. The opposed linear sides of the cap are provided with depending channel portions that are disposed to slidably engage the flanges at the sides of the opening, so that the cap may be slidably secured to the spout/funnel. The cap may close the entire spout/funnel upper opening to retain paint within the container and prevent dust or debris from falling into the container. The cap may also be slidably translated to partially unblock the upper opening of the spout/funnel so that paint may be poured out therefrom, and the position of the cap with respect to the opening enables the user to meter and control the rate of outflow of paint.

The cap of the spout/funnel may also be removed entirely to reveal the entire upper opening thereof. In this disposition, the spout/funnel may serve its latter purpose; that is, paint from another source may be poured into the funnel and thence into the container. This function enables the user to reclaim unused paint; e.g., from a paint roller tray, or another container that is partially filled with paint, or the like.

The invention also provides a mixing device for stirring and blending paint within the paint container. The mixing device includes a shaft having a plurality of curved vanes extending generally radially from the lower end of the shaft and spaced at equal angles thereabout. The upper end of the shaft is configured to be engaged in the chuck of any common rotary power device, such as a drill, screw driver, or the like. The array of vanes is dimensioned to be received through the opening in the adapter ring, so that it may be employed in any container fitted with the lid of the present invention. In addition, the lid of the invention may be provided with a secondary hole for receiving the shaft, so that mixing device may be placed in the container with the shaft extending from the secondary hole and the adapter ring opening is free for pouring and receiving paint.

Note that although the invention is described with respect to paint and paint containers, it may be applied to any liquid that is sold and used in similar containers.

### BRIEF DESCRIPTION OF THE DRAWING

FIG. 1 is a perspective view of a large standard paint container with the adapter ring and pour spout/funnel of the invention installed on the lid of the container.

FIG. 2 is a perspective view of a small standard paint container with the adapter ring and pour spout/funnel of the invention installed on the lid of the container.

FIG. 3 is a partial perspective view as in FIG. 1, showing the spout/funnel cap in the open position.

FIG. 4 is a partial perspective view as in FIG. 2, showing the spout/funnel cap in the open position and the container tilted to pour paint from the spout/funnel.

FIG. 5 is an exploded view showing the components of the adapter ring assembly of the invention with a lid of a large standard paint container.

FIG. 6 is an exploded view showing the adapter ring cap and spout/funnel of the of the invention with a lid of a large standard paint container.

FIG. 7 is a partial cross-sectional elevation taken along line 7-7 of FIG. 1, showing the spout/funnel supported on the lid of a large standard paint container.

FIG. 8 is a partial cross-sectional elevation taken along line 8-8 of FIG. 2, showing the spout/funnel and its cap.

FIG. 9 is a plan view of the cap of the spout/funnel of the invention. FIG. 10 is a partial cross-sectional elevation of the mixing device of the invention introduced through the adapter ring assembly of a large standard paint container.

FIG. 11 is a lower end view of the mixing device of the invention.

FIG. 12 is a partial perspective view of a small standard paint container with the lid thereof supporting the spout/funnel and the shaft of the mixing device extending through a secondary hole in the lid.

FIG. 13 is a partial perspective view as in FIG. 3, showing the spout/funnel being used as a funnel to receive and direct paint poured into the container.

### DETAILED DESCRIPTION OF THE INVENTION

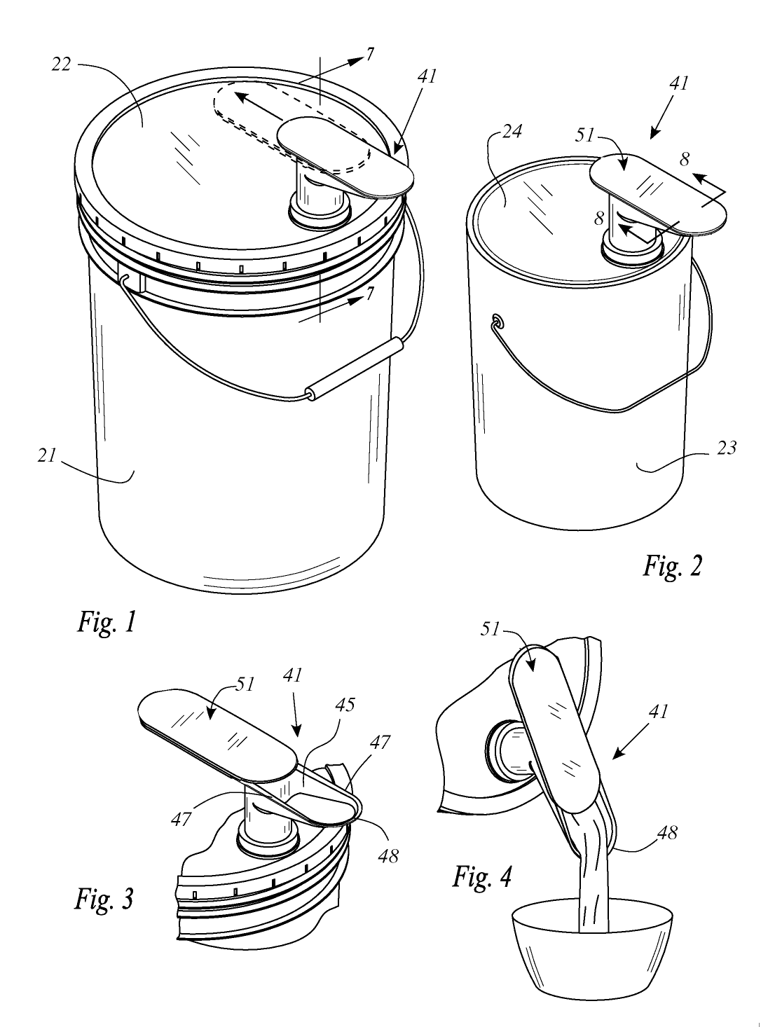

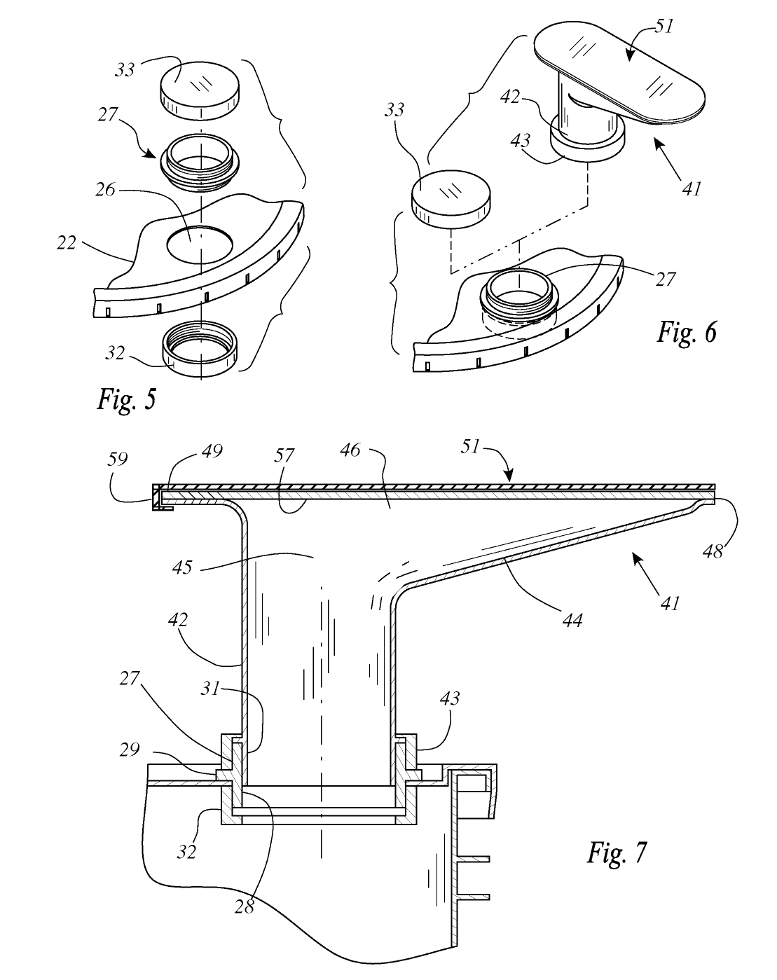

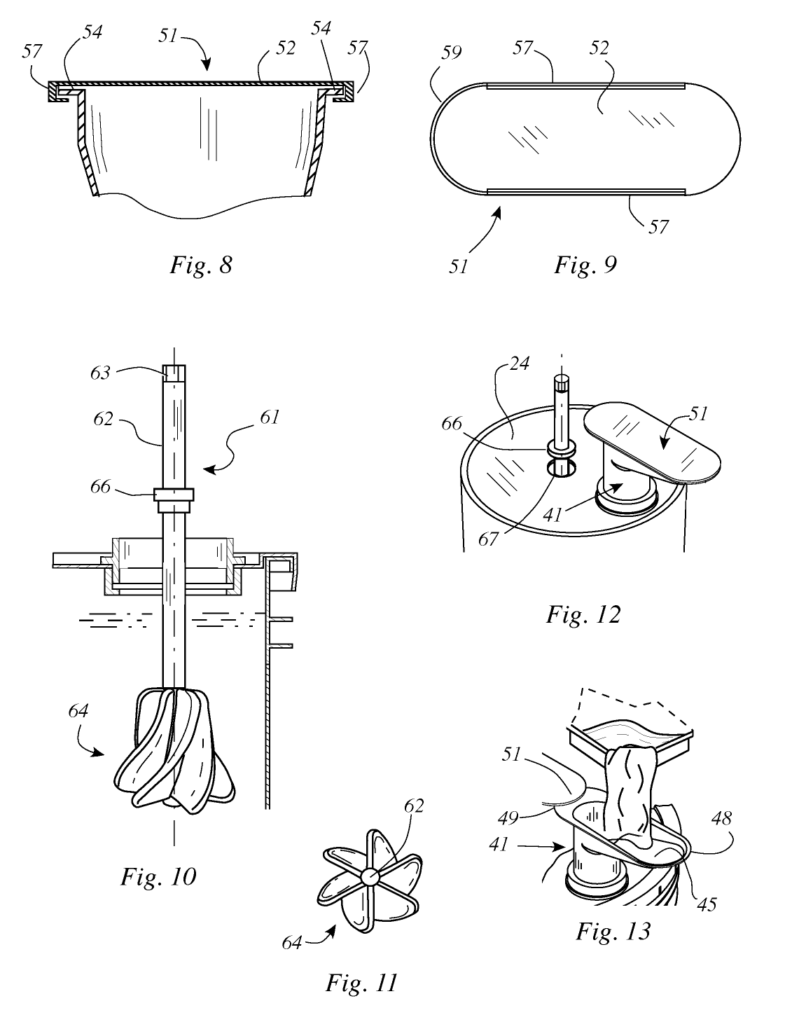

The present invention generally comprises a paint container lid assembly that incorporates a pour spout and funnel, and facilitates easy access to the paint without causing the spills and mess often associated with paint containers. With regard to FIGS. 1 and 2, there is known in the prior art a typical large paint container 21, such as a 5 gallon bucket or can, which is typically provided with a lid 22 removably secured to the open upper end. Likewise, a typical small paint container 23, such as a one gallon bucket or can, is typically provided with a lid 24 removably secured to the open upper end. The present invention may be employed with either lid 22 or 24, or any other lid for a standard liquid container.

As shown in FIGS. 5-7, the lid 22 (or 24) is provided with an access opening 26 comprising a circular hole extending therethrough and disposed adjacent to the perimeter rim of the lid. An adapter ring 27 comprises a tubular component having a lower end 28 dimensioned to extend through the opening 26, and a medial flange 29 extends radially from the ring 27 and is wider than the opening 26 to impinge on the outer surface of the lid. The upper end of the adapter ring 27 is provided with external threads and comprises a collar 31 that projects upwardly from the upper surface of the lid. A retaining ring 32 includes internal threads to engage the lower threaded 28 and secure the adapter ring in the opening 26, as shown in FIGS. 6 and 7. A threaded cap 33 is provided to engage the threaded collar 31 and seal the opening of the adapter ring 27.

Note that some prior art container lids are provided with the components 26-33 as an OEM feature, and these elements are not an independent part of the invention. However, in cases where the lid 22 or 23 is not provided with an adapter ring assembly, the invention provides a replacement lid to accomplish the purposes described below.

With regard to FIGS. 6 and 7 in particular, a spout/funnel 41 is provided and designed to be removably secured to the adapter ring, as suggested in FIG. 6. The spout/funnel 41 includes a lower tubular end 42 having an internally threaded portion 43 that is configured for complementary engagement with the threaded collar 31. A sidewall 44 extends from the lower tubular end 42 and flares radially and outwardly and radially asymmetrically in a smoothly contoured manner. The upper end of the sidewall 44 forms a receptacle 45 with an upper opening 46 that is elongated radially (with respect to the axis of the tubular end 42) and is defined by opposed parallel linear edges 47 and fully radiused ends 48 and 49. As shown particularly in FIG. 7, the end 48 of the spout/funnel 41 is disposed radially outwardly of the sidewall of the container 21 or 23, so that pouring liquid from the spout/funnel is greatly facilitated.

The invention also includes a cap 51 for the spout/funnel 41, as shown particularly in FIGS. 8 and 9. The cap 51 includes a planar component 52 having an outer perimeter generally the same as the opening 46, so that the opening may be entirely closed by the cap. In addition, the cap includes channel portions 57 depending from opposed sides thereof that are parallel to the sides 47 of the spout/funnel. The edges 47 are provided with flanges 54 extending outwardly therefrom in opposed relationship and disposed to engage the channels 57 of the cap 51. Thus the cap 51 may be slidably engaged on the top of the spout funnel 41. A flange 59 depends from one end of the cap 51 and is disposed to impinge on the end 49 of the spout/funnel to act as a stop when the cap 51 engages the spout/funnel in a fully closed disposition, as shown in FIGS. 1, 2, 6, and 12.

In the fully closed cap disposition, no dust, debris, or construction waste may enter the container 21 or 23 and the paint is protected from contamination. An important aspect of the invention is that the cap 51 may be slidably opened to a selective and varying extent, whereby when paint is poured from the container, the outflow may be controlled and metered by the position of the cap 51, as suggested in FIG. 4. This feature enables pouring small quantities, or pouring at small flow rates, as befits the task at hand. Alternatively, the cap 51 may be slidably positioned at a fully open disposition, as shown in FIGS. 3 and 13, to facilitate pouring at a fast flow rate. Likewise, the cap 51 may be removed altogether when necessary, and replaced as needed.

The spout/funnel 41 may be used reversibly to add paint to the container on which it is installed. As shown in FIG. 13, the cap 51 may be opened fully or removed entirely and paint may be poured into the receptacle portion 45 of the spout/funnel, where it then flows gravitally into the container. In this regard the wide, elongated opening 46 is superior in enabling accepting liquid from containers such as paint roller trays (as shown in FIG. 13) or other paint cans and buckets, which often outflow in wide streams. This feature facilitates collecting paint from a plurality of sources without spillage and the attendant cleanup work.

A further aspect of the invention is the provision of a mixing device 61, as shown in FIGS. 10-12, for use with the other components for stirring and blending paint within the paint container. The mixing device 61 includes a shaft 62 extending along an axis, and the upper end includes a configuration 63 (such as the flats shown) for engaging the chuck of a rotary drive device (not shown). At the lower end of the shaft a plurality of vanes 64 extend outwardly therefrom in equal-angle spacing to assure rotational balance. The vanes 64 are curved in identical form so that the mixing device stirs the liquid paint without creating air bubbles that would compromise the uniform application of the paint. The shaft also includes a stepped annular shoulder 66 at a medial portion thereof.

The mixing device 61 may be employed as shown in FIG. 10 by extending the lower end thereof through the opening of the adapter ring assembly to submerge the vanes in the liquid in the container, whereafter the shaft is rotated by a power tool such as a rotary drill to mix and stir the paint to the desired consistency and uniformity. For this use the outside diameter of the vane assembly must be less than the inside diameter of the adapter ring. Alternatively, the lid 24 of the invention may be provided with a secondary hole 67 for receiving the shaft 62, so that mixing device may be placed in the container with the shaft extending from the secondary hole 67 and the adapter ring opening is free for pouring and/or receiving paint. The stepped annular shoulder 66 serves to occlude the secondary hole 67 and prevent paint from splashing outwardly therefrom.

The invention provides a paint container system that alleviates much of the spills and drips that cause time-consuming cleanup work. The adapter ring 27 provides a pouring outlet that is available without necessitating removing the top 22 or 24 of the container, and it is resealable using the cap 33. The spout/funnel assembly 41 may be removably threaded onto the adapter ring 27 for pouring paint from the container, or for acting as a funnel for receiving paint from other containers. If the spout/funnel remains installed on the container lid, it may be closed using the cap 51 to prevent contaminants falling therethrough into the paint container. Furthermore, the cap 51 may be partially opened to act as a metering and flow control device for pouring paint into small containers and the like. The mixing device may be used through the opening of the adapter ring, whether or not the spout/funnel is installed, or may be used through the secondary hole 67 that is provided by the invention.

In a preferred embodiment of the invention, the opening of the adapter ring assembly is approximately 2.0-3.0 inches in diameter, and the spout/funnel 41 is approximately 7.0-8.0 inches long and 2.0-4.0 inches wide at its upper extent. These dimensions are stated to show a practical embodiment but are not considered to be limiting requirements.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. In a paint container lid assembly including a lid adapted to removably close the paint container opening, the improvement comprising:
an access opening extending through the lid;
an adapter ring secured in said access opening and including an upper end forming a threaded collar;
a threaded cap removably secured to said threaded collar;
a spout/funnel having a threaded lower end adapted to be removably secured to said threaded collar, said spout/funnel having an elongated upper opening adapted for both receiving paint poured therein and for discharging paint poured therefrom.

2. The paint container lid assembly of claim 1, further including a spout/funnel cap removably secured to the upper end of said spout/funnel and adapted to close said elongated upper opening.

3. The paint container lid assembly of claim 2, wherein said spout/funnel cap is slidably engaged with said spout/funnel and adapted to be opened to a selective and varying extent to meter and control paint outflow poured from said spout/funnel.

4. The paint container lid assembly of claim 3, wherein said elongated upper opening is defined in part by a pair of opposed elongated linear sides, and further including a pair of flanges, each extending from one of said opposed elongated linear sides.

5. The paint container lid assembly of claim 4, wherein said spout/funnel cap includes a pair of linear channel portions disposed to engage said pair of flanges in slidable fashion.

6. The paint container lid assembly of claim 1, wherein said threaded lower end of said spout funnel is generally tubular, and further including a sidewall extending upwardly therefrom to said elongated upper opening in smoothly contoured fashion.

7. The paint container lid assembly of claim 1, further including a rotatable paint mixing device dimensioned to be received through said spout/funnel and said adapter ring to stir paint within the container.

8. The paint container lid assembly of claim 7, wherein said paint mixing device includes a rotatable shaft and a plurality of vanes secured to a lower end of said rotatable shaft and extending generally radially outwardly therefrom.

9. The paint container lid assembly of claim 8, wherein said plurality of vanes define a maximum diameter that is less than the internal diameter of said adapter ring and said spout/funnel.

10. The paint container lid assembly of claim 8, further including a secondary opening in said lid for receiving said shaft therethrough.
